(19) United States
(12) Patent Application Publication
(10) Pub. No.: US 2008/0176033 A1
(43) Pub. Date: Jul. 24, 2008

(54) Apparatus and methods for removing a fluid from an article

(75) Inventor: David Kwoka, South Glastonbury, CT (US)

Correspondence Address: PRATT & WHITNEY, 400 MAIN STREET, MAIL STOP: 132-13, EAST HARTFORD, CT, 06108, US

(73) Assignee: United Technologies Corporation

(21) Appl. No.: 11/657,369

(22) Filed: Jan. 24, 2007

(51) Int. Cl. B32B 3/10

(52) U.S. Cl. 428/131

(57) ABSTRACT

Disclosed are exemplary apparatus and methods for removing a fluid from an article. A guide tube is extended into the article so that a tube first end resides in a region proximate the fluid. The guide tube is a rigid, semi-rigid or flexible member, allowing the tube to circumvent obstructions in the article. A wick, made of an absorbent material, is inserted into the tube until a wick first end is proximate the tube first end and is in contact with the fluid. Capillary action draws the fluid into the wick first end, where it is transferred to an opposite, wick second end that is disposed in a collection vessel. The vessel may contain an absorbent material to speed the removal process and simplify the disposal of the fluid. After removal, the fluid may be disposed of in an environmentally conscious manner.

This invention was made with Government support under F33657-99-D-2051-0013 awarded by the United States Air Force. The Government has certain rights in this invention.

### BACKGROUND OF THE INVENTION

(1) Field of the Invention

The invention relates to components preserved with fluid and more specifically to an apparatus and method for removing accumulated preservation fluid in an environmentally conscious manner.

(2) Description of the Related Art

Gas turbine engines typically power aircraft, ships and electrical generators. After original equipment manufacturing (OEM) and subsequent overhaul and repair (O&R) shop visits, an engine is test run to break in mating parts and to ensure the engine meets operational performance limits. Since a lengthy period of time may occur between a test run and actual service use, an engine's internal and external components must be protected from corrosion.

At the end of a typical test run, the engine's rotational speed is reduced to idle while the fuel supply is switched from aviation fuel to preservation fluid. A preservation fluid such as type 1010, specified in MIL-PRF-6081D or the like, is typically used in gas turbine applications. The preservation fluid coats the fuel system and other internal components, thus forming a protective barrier against corrosion. After the engine idles for a period of time with preservation fluid as the fuel source, the engine is shut down and packaged for storage and/or shipment to a customer.

During extended shipment and storage periods, such as with spare engines, residual preservation fluid accumulates in pools in the lowest areas of engines due to gravity. One such area is located in the diffuser case, downstream of the fuel nozzles and upstream of the first turbine vane and blade outer air seal (BOAS). Upon subsequent engine startup, the accumulated preservation fluid can ignite, leading to oxidation damage of brand new or newly refurbished components. The BOAS segments are particularly susceptible to damage due to their close proximity to the accumulated preservation fluid. If visual inspection establishes that the BOAS segments or other components are damaged, the engine must be disassembled for repair. Engine disassembly is both time consuming and can be rather expensive.

As an alternative, engines may be stored for extended periods without the use of preservation fluid. To prevent the formation of corrosion, these engines must be started at regular intervals. Periodic engine starting vaporizes accumulated condensation and purges the fuel system components of harmful corrosion. This procedure is time consuming, expensive, requires trained personnel and specialized test facilities.

Draining the preservation fluid is not always feasible. Access ports are not always available in the exact area where preservation fluid accumulates. Dedicated ports for preservation fluid removal add weight, complexity and manufacturing cost to an engine. Existing plugs may be located near the preservation fluid pools, and a specialized vacuum may be used to remove the fluid. Vacuuming requires a power source, specialized equipment and extensive training for personnel to avoid collateral damage to adjacent engine components. Drain plugs and vacuums may also allow preservation fluid spillage onto the ground, creating environmental remediation concerns.

What is presently needed is a simple, environmentally conscious apparatus and method for removing a fluid from an area of an article such as a diffuser case of a gas turbine engine.

### BRIEF SUMMARY OF THE INVENTION

In accordance with the present invention, an apparatus and method for removing a fluid from an article are provided.

In an exemplary apparatus, a guide tube includes a body, a first end and a second end. A collection vessel is disposed proximate the tube second end to serve as a reservoir for the removed fluid. A wick is disposed in the tube body with a first wick end proximate the tube first end, in contact with a fluid, and a second wick end extending into the vessel. The wick material permits capillary transfer of the fluid from the apparatus, through the wick, to the vessel.

In an exemplary method, a region proximate the fluid is first exposed. A first end of a guide tube is extended into the region. A first end of a wick is then inserted into a second end of the tube and advanced into the guide tube until the first end of the wick contacts the fluid. The fluid is drawn into the first end of the wick and transferred to a second end of the wick through capillary action. The fluid is lastly collected from the second end of the wick and disposed of in an environmentally conscious manner.

A primary advantage of the present invention is the ability to remove fluids from regions of an apparatus that are difficult to access. The method requires a minimal level of skilled labor and the apparatus cost is low. Once installed, the apparatus passively removes residual fluids over the duration of the storage period. Also, the fluids are able to be collected and disposed of in an environmentally conscious manner.

These and other objects, features and advantages of the present invention will become apparent in view of the following detailed description and accompanying figures of multiple embodiments, where corresponding identifiers represent like features between the various figures.

### BRIEF DESCRIPTION OF THE SEVERAL VIEWS OF THE DRAWINGS

FIG. 1 illustrates an exploded view of a fluid removal and collection apparatus according to an embodiment of the present invention;

FIG. 2 illustrates a partial cross sectional view of a first embodiment of a guide tube of the apparatus of FIG. 1;

FIG. 3 illustrates a partial cross sectional view of a second embodiment of a guide tube of the apparatus of FIG. 1;

FIG. 4 illustrates a partial cross sectional view of a third embodiment of a guide tube of the apparatus of FIG. 1; and

FIG. 5 illustrates a simplified cross sectional view of the apparatus of FIG. 1, removing accumulated preservation fluid from a diffuser case of a gas turbine engine.

### DETAILED DESCRIPTION OF THE INVENTION

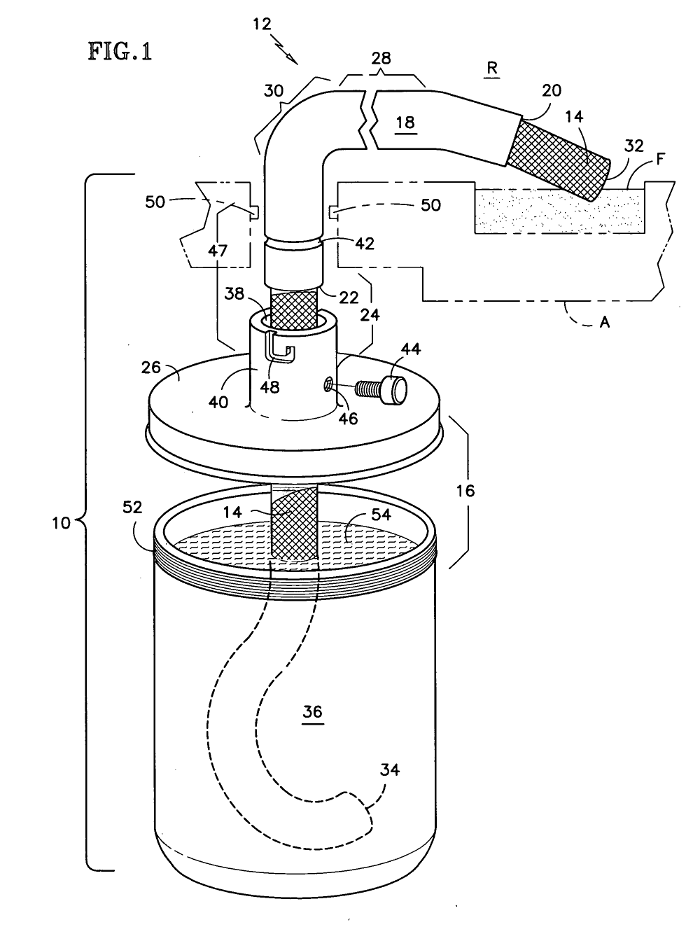

Referring first to FIG. 1, a fluid removal apparatus 10 broadly comprises a guide tube 12, a wick 14 and a collection vessel 16. The guide tube 12 directs the wick 14 to a fluid F, located in an article A, for transfer to the collection vessel 16. Once removed, the fluid can be disposed of in an environmentally conscious manner. The wick 14 draws the fluid F pool out of the article A by capillary action. Capillary action occurs when the adhesive intermolecular forces between the fluid F and the porous wick 14 are stronger than the cohesive intermolecular forces within the fluid F itself.

The guide tube 12 is a hollow, thin-walled body, having an internal passageway that is nonporous, unobstructed and as smooth as possible. The guide tube 12 directs the wick 14 around obstructions in the article A to the fluid F. Preferably, the passageway has a cross sectional shape that matches the wick's 14 cross sectional shape, but they may also be shaped differently. Although a circular shaped profile is illustrated throughout the figures, other shapes such as square and oblong would function appropriately and are also contemplated. The guide tube 12 preferably has a rigid body 18, but the body 18 may also be semi-rigid or flexible, depending on the accessibility of the fluid F. A tube first end 20 is disposed in a region R, proximate the fluid F pool, and an opposite, tube second end 22 is disposed proximate the collection vessel 16. The tube second end 22 includes means 24 for attaching the tube second end 22 to a lid 26 of the collection vessel 16. Suitable attachment means 24 and other details of the guide tube 12 are described in great detail later. Between the tube first 20 and second 22 ends, the tube body 18 may have one or more straight 28 or curved 30 sections to direct the wick 14 around obstructions.

The wick 14 functions as a conduit for transferring the fluid F pool from the article A to the collection vessel 16 by means of capillary action. The wick 14 is a woven, flexible or semi-rigid member made of an absorbent material. For example, the wick material may be cotton, hemp, wool, paper, or any other absorbent material known in the art. The cross sectional profile of the wick 14 is preferably the same as the guide tube body 18 and is slightly smaller to allow insertion and advancement through the entire length of the body 18 without binding. The wick 14 has a first end 32 disposed proximate the fluid F and an opposite, second end 34 disposed within the collection vessel 16.

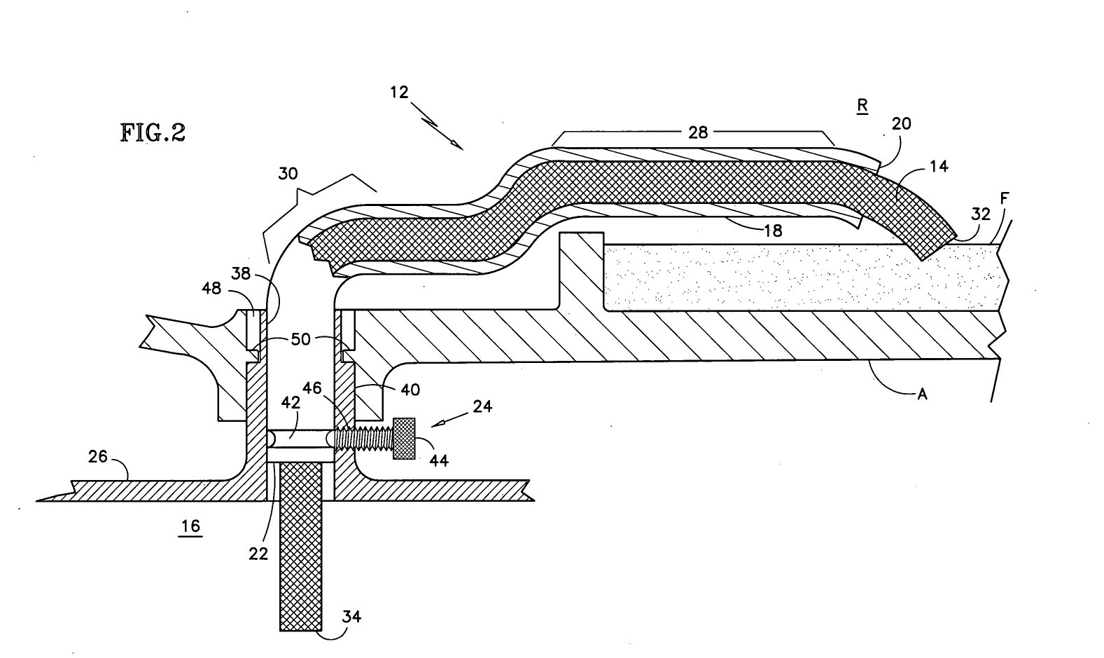

The collection vessel 16 comprises an upper lid 26 and a lower cup 36. As previously described, the lid 26 is affixed to the tube second end 22 by attachment means 24. An aperture 38 through a raised flange 40 accepts the tube second end 22. In the example shown, a groove 42 circumscribes the outer diameter of the tube second end 22. The groove 42 accepts a set screw 44 advanced through a threaded aperture 46 in the flange 40. The position of the guide tube 12, in relation to the lid 26, may be adjusted by loosening the set screw 44 and rotating the tube 12. The flange 40 also contains means 47 for attaching the fluid removal apparatus 10 to the article A. In the example shown, a pair of female grooves 48 engage corresponding male pins 50 (FIG. 2) located on the article A. The example attachment means 47 is sometimes referred to as a bayonet fitting and provides a positive attachment and precise alignment.

The cup 36 collects the fluid F for later disposal in an environmentally conscious manner. The cup 36 attaches to the lid 26 at a threaded connection 52 about its open end. Clips, fasteners, or other attachment means known in the art may also be used. With the lid 26 attached to the cup 36, the wick second end 34 extends into the cup 36. An absorbent material 54 may be disposed in the cup 36, surrounding a portion of the wick second end 36. The absorbent material 54 speeds the fluid F removal process and simplifies the disposal of the collected fluid F. The absorbent material 54 may be corncob, cellulose, paper, peat moss, polypropylene or other absorbent material known in the art. The volume of the cup 36 is preferably larger than the volume of the removed fluid F to ensure complete removal without fluid F spillage.

FIGS. 2-5 illustrate further details of various embodiments of a fluid removal apparatus 10. In a first embodiment of FIG. 2, a lid 26 is attached to an article A by engaging pins 50 with corresponding grooves 48 in the flange 40. The guide tube 12 is a preformed, rigid member with a body 18 comprised of both straight 28 and curved 30 portions. The preformed body 18 allows repeatable access to a region R proximate the fluid F.

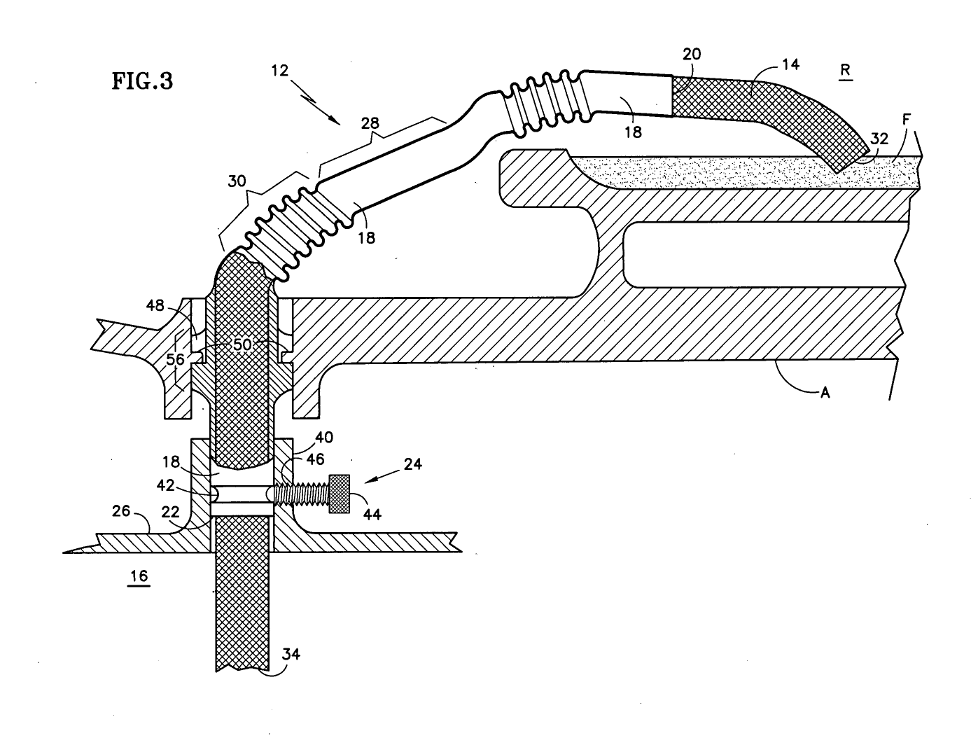

In another embodiment of FIG. 3, a lid 26 is attached to an article A by engaging pins 50 with corresponding grooves 48 in the tube second end 22. The grooves 48 reside in an oversized region 56 of the tube second end 22, instead of in the flange 40 as in the previous example. The guide tube 12 is a preformed, semi-rigid member with a body 18 comprised of rigid, straight 28 portions and flexible, curved 30 portions. Corrugations form the curved portions 30 in the example, but swivel joints, ball joints or other flexible means may also be used. The corrugated, curved portions 30 allow for slight adjustments of the tube 12 in order to allow access to a region R that is difficult to access with a completely rigid tube body 18.

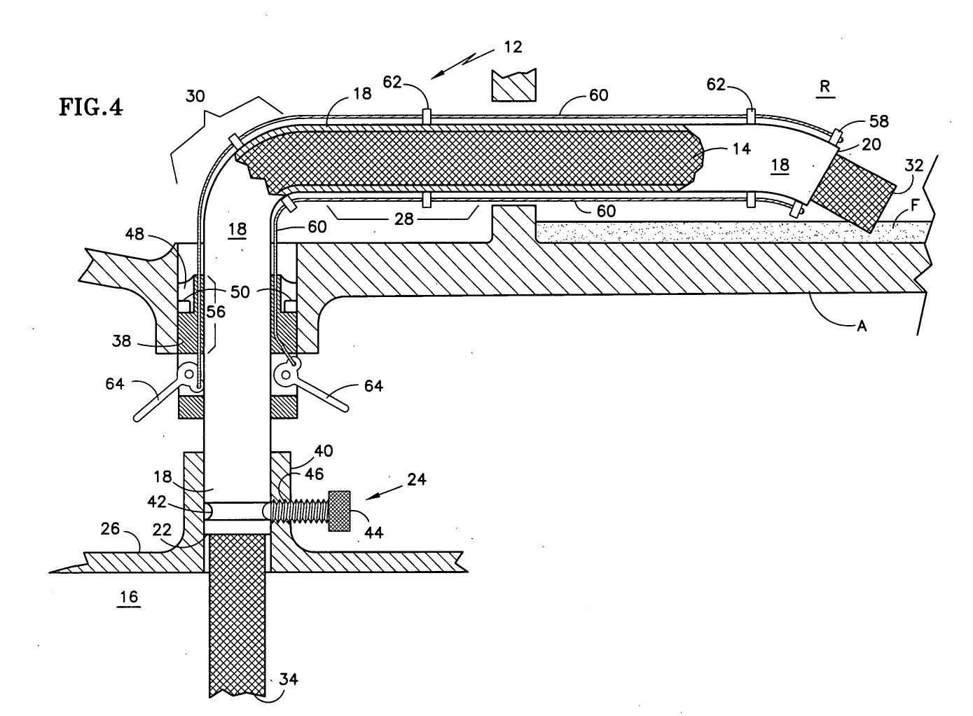

In yet another embodiment of FIG. 4, a lid 26 is attached to an article A by engaging pins 50 with corresponding grooves 48 in the tube second end 22. The grooves 48 reside in an oversized region 56 of the tube second end 22, instead of in the lid 26 as in the first example. The guide tube 12 is a flexible member with a body 18 comprising an externally mounted manipulation system. The tube first end 20 is manipulated by a guide ring 58 affixed to one or more guy cables 60 threaded through eyelets 62 secured to the tube body 18. Levers 64, rotatably secured to the tube second end 22, selectively contract or extend the guy cables 60. Multiple levers 64 and guy cables 60 allow precise manipulation of the tube first end 20. The enhanced manipulation of the tube first end 20 allows access to a region R that is even more difficult to access with a rigid or semi-rigid tube body 18.

In some embodiments, the guide tube 12 body 18 may be made of two or more individual segments. For example, a first segment may contain grooves 48 for engaging pins 50 to form the attachment means 47, while a second segment may contain the straight 28 and curved 30 portions. The first segment may extend a distance away from the article A to form a sleeve for the second segment to fit within.

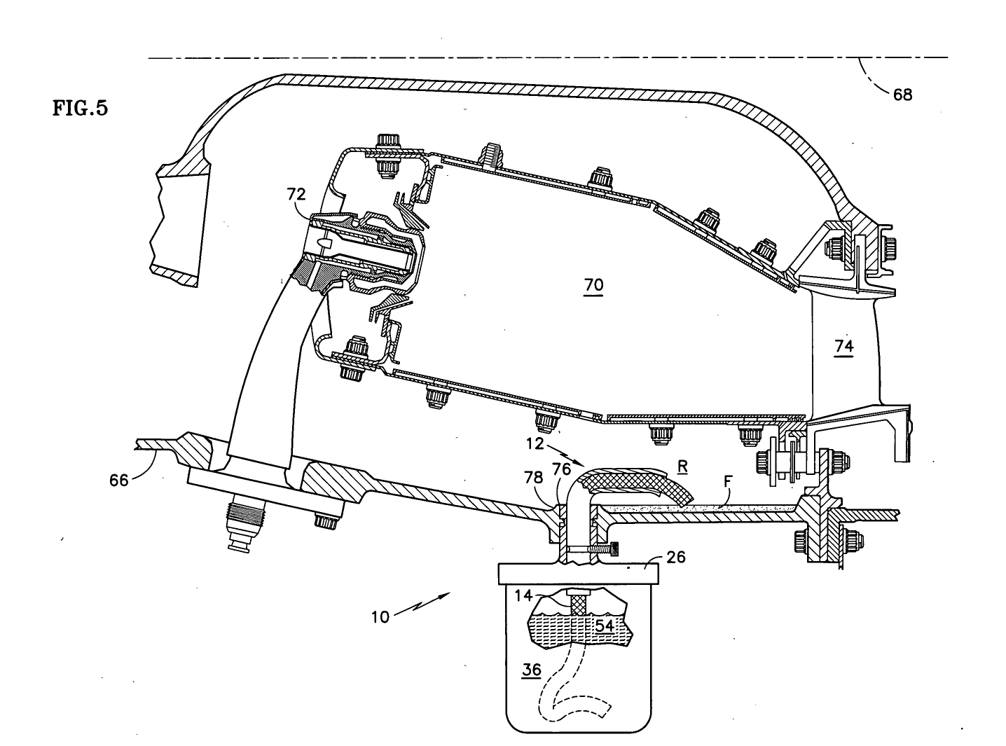

Referring now to FIGS. 1 and 5, an exemplary diffuser case 66 is disposed circumferentially about a longitudinal axis 68 of a gas turbine engine. An annular combustor 70 burns fuel and preservation fluid (F) injected from fuel nozzles 72, spaced about the diffuser case 66. The preservation fluid F accumulates in pools at the radially lower-most region of the diffuser case 66. This region is upstream of the first stage of turbine vanes 74 and the BOAS (not shown). An existing port 76 provides access to the combustor 70 for periodic visual inspection via a boroscope; however, an inner boss 78 prevents draining of the preservation fluid F by gravity. As was discussed earlier, ignition of the accumulated preservation fluid F may cause damage to the surrounding components and removal is necessary prior to engine starting.

An exemplary method for removing a pool of preservation fluid F from the diffuser case 66 begins by exposing a region R. proximate the fluid F. In the example shown, a boroscope inspection plug (not shown) is first removed to gain access to the region R. In other examples of the method, a fuel nozzle 72 or other component may be removed to expose the region R. A tube first end 20 is then introduced through the port 76, proximate to the region R. The guide tube 12 may or may not be affixed to the lid 26 of the collection vessel 16 at this time. Once the guide tube 12 is properly positioned, a wick first end 32 is inserted into the tube second end 22 and advanced into the tube body 18 until the wick first end 32 contacts the fluid F. A wick second end 34 is inserted in the cup 36 of the collection vessel 16, which is attached to the lid 26 at a threaded connection 52. The cup 36 may or may not contain an absorbent material 54 of the type previously described. The apparatus 10 is attached to the article A by attachment means 47. In this example, the apparatus 10 is attached by engaging pins 50 with corresponding grooves 48 in the tube second end 22, forming a bayonet fitting. Capillary action draws the fluid F into the wick first end 32 and transfers the fluid F to the wick second end 34, where it accumulates in the cup 36. Lastly, the accumulated fluid F is disposed of in an environmentally conscious manner. Preferably, the fluid is disposed of in compliance with all local, state, federal AND international regulations governing the handling and disposal of the fluid F.

Other alternatives, modifications and variations will become apparent to those skilled in the art having read the foregoing description. For example, the fluid removal method and apparatus may be used in the manufacturing industry to remove fluids from machinery. Accordingly, the invention embraces those alternatives, modifications and variations as fall within the broad scope of the appended claims.

What is claimed is:

1. A method of removing a fluid from an article comprising the steps of:
a. exposing a region proximate the fluid;
b. extending a first end of a guide tube into the region;
c. inserting a first end of a wick into a second end of the guide tube;
d. advancing the wick into the guide tube until the first end of the wick contacts the fluid;
e. drawing the fluid into the first end of the wick and transferring the fluid to a second end of the wick by capillary action; and
f. collecting the fluid from the second end of the wick.

2. The method of claim 1, wherein the exposing step includes removing a plug from a port.

3. The method of claim 2, wherein the exposing step includes removing the plug from a boroscope inspection port.

4. The method of claim 1, wherein the extending step further includes orienting the end toward the fluid.

5. The method of claim 1, wherein the extending step further includes engaging the guide tube with the article.

6. The method of claim 5, wherein the guide tube is engaged with the article with a bayonet fitting.

7. The method of claim 1, wherein the collecting step includes absorbing the fluid with an absorbent material.

8. The method of claim 7, wherein the collecting step further includes disposing of the collected fluid in an environmentally conscious manner.

9. An apparatus for removing a fluid from an article, said apparatus comprising:
a guide tube including a body with a first end and an opposite, second end;
a collection vessel proximate the second end;
a wick, said wick being disposed in said tube body with a first wick end proximate the tube first end, and a second wick end extending into the vessel; and
wherein the wick material permits capillary transfer of the fluid from the article to the vessel.

10. The apparatus of claim 9, wherein the tube body is rigid.

11. The apparatus of claim 10, wherein the tube body contains a curved portion.

12. The apparatus of claim 9, wherein the tube body is semi-rigid.

13. The apparatus of claim 9, wherein the tube body is flexible.

14. The apparatus of claim 9, wherein the tube second end contains means for attaching the apparatus to the article.

15. The apparatus of claim 14, wherein the attaching means comprises a portion of a bayonet fitting.

16. The apparatus of claim 9, wherein the collection vessel contains an absorbent material therein and the absorbent material contacts the wick second end.

17. The apparatus of claim 16, wherein the absorbent material is chosen from the group consisting of corncob, cellulose, paper, peat moss and polypropylene.

18. The apparatus of claim 9, wherein the wick material is chosen from the group consisting of cotton, hemp, wool, and paper.

19. The apparatus of claim 9, wherein the collection vessel contains a removable lid, the lid being attached to the tube second end.

20. The apparatus of claim 19, wherein the lid contains means for attaching the apparatus to the article.

21. The apparatus of claim 20, wherein the attaching means comprises a portion of a bayonet fitting.

22. The apparatus of claim 9, wherein the guide tube body comprises two or more segments, and a first one of the segments contains means for attaching the apparatus to the article.

23. The apparatus of claim 22, wherein a second one of the segments fits within the first one of the segments.
